(19) United States
(12) Patent Application Publication
(10) Pub. No.: US 2026/0050132 A1
(43) Pub. Date: Feb. 19, 2026

(54) PASSIVELY ALIGNED DEMOUNTABLE OPTICAL CONNECTOR AND PRELOAD THEREFOR

(71) Applicant: Senko Advanced Components, Inc., Hudson, MA (US)

(72) Inventors: Robert Ryan VALLANCE, Newbury Park, CA (US); King-Fu HII, Newbury Park, CA (US); Yang CHEN, Thousand Oaks, CA (US)

(21) Appl. No.: 19/300,638

(22) Filed: Aug. 14, 2025

Related U.S. Application Data
(60) Provisional application No. 63/682,981, filed on Aug. 14, 2024.

(51) Int. Cl. G02B 6/42

(52) U.S. Cl. CPC G02B 6/4292; G02B 6/4243

(57) ABSTRACT

Attaching an optical connector to an optoelectronic device via a foundation thereon is achieved by kinematic coupling, quasi-kinematic coupling, or elastic-averaging coupling. The foundation is attached to the optoelectronic device with reference to optical ports in the optoelectronic device. For kinematic coupling, coupling balls and grooves are provided on facing surfaces of the optical connector and the foundation. An optical bench of the optical connector is positioned in a central space on the foundation. A preload is applied along a line through the thermal center of the coupled foundation and optical connector without introducing lateral bias, ensuring the contact between the foundation and optical connector.

### PRIORITY CLAIM

This application claims the priority of U.S. Provisional Patent Application No. 63/682,981 filed on Aug. 14, 2024. This application is fully incorporated by reference as if fully set forth herein. All publications noted below are fully incorporated by reference as if fully set forth herein.

### BACKGROUND OF THE INVENTION

### Field of the Invention

The present invention relates to coupling of light into and out of optoelectronic devices (e.g., photonic integrated circuits (PICs)), and more particularly to demountable couplings based on passive alignment between optical connectors and optoelectronic devices.

### Description of Related Art

Photonic integrated circuits (PICs) or integrated optical circuits are part of an emerging technology that uses light as a means of communication, computing, or sensing as opposed to an electric current. A PIC integrates multiple (at least two) photonic functions and as such is analogous to an electronic integrated circuit. The major difference between the two is that a photonic integrated circuit provides functionality for information signals on optical wavelengths typically in the visible spectrum or near infrared 850 nm-1650 nm.

PICs are used for various applications in telecommunications, networking, instrumentation, sensing, and signal-processing fields. The PIC typically uses optical waveguides to route optical signals throughout the PIC and/or to interconnect various elements, such as optical switches, couplers, routers, splitters, multiplexers/demultiplexers, modulators, amplifiers, wavelength converters, optical-to-electrical (O/E) (e.g. photodiodes) and electrical-to-optical (E/O) converters (e.g. lasers), etc. A waveguide in a PIC device is usually an on-PIC solid light conductor that guides light due to an index-of-refraction difference between the waveguide's core material and cladding material.

For proper operation, a PIC needs to efficiently couple light signals between an external optical fiber and one or more on-chip waveguides. An advantage of using light as a basis of circuit operation in a PIC is that its energy cost for high-speed signal transmission is substantially less than that of electronic chips on printed circuit boards (PCBs), thus efficient signal transmission between PIC devices and other optical devices, such as optical fibers, that maintains this advantage is an important aspect of PICs. Most PICs require single-mode optical connections that require stringent alignment tolerances between optical fibers and the PIC, typically less than 1 micrometer, for efficient optical coupling resulting in an unacceptable insertion loss (e.g., >10 dB).

US Patent Publication No. 2016/0161686A1 (commonly assigned to the assignee of the present application and fully incorporated by reference herein) discloses precision passive alignment based connectable and disconnectable and reconnectable (hereinafter simply referred to as demountable) optical connections for optoelectronic devices (e.g., PICs). The demountable connection is between an optical connector having an optical bench supporting an optical fiber and a photonic integrated circuit (PIC) having a receptacle or foundation. The optical connector and foundation are configured and structured for the optical connector to be removably attachable for reconnection to the foundation in alignment therewith. The foundation which is permanently attached with respect to the optoelectronic device, is aligned to electro-optical elements in the PIC. Demountable passive alignment connection between the foundation and the optical connector is achieved by providing complementary passive alignment features on the facing surfaces of the foundation and optical connector, conforming to a passive alignment coupling including kinematic coupling, quasi-kinematic coupling, or elastic-averaging coupling.

US Patent Publication No. 2024/0027703A1 (commonly assigned to the assignee of the present application and fully incorporated by reference herein) discloses a precision demountable connection of an optical connector to an optoelectronic device using a foundation having features for integrated optical coupling and demountable coupling. The foundation is permanently attached and aligned to a PIC chip. U.S. Pat. No. 11,500,166 (commonly assigned to the assignee of the present application and fully incorporated by reference herein) further discloses specific embodiments of precision demountable passive alignment couplings based on elastic averaging. US Patent Publication No. 2024/0142722A1 (commonly assigned to the assignee of the present application and fully incorporated by reference herein) discloses further embodiments of elastic averaging alignment features that are well suited for precision demountable passive alignment coupling between optical connectors and optoelectronic devices.

The various types of demountable passive alignment couplings require a preload to bias the connection between the coupled optical connector and foundation, maintaining coupling of the complementary passive alignment features provided on the facing surfaces of the foundation and optical connector. The preload helps maintain contact despite external forces and environmental factors, and it is crucial for achieving high repeatability in the coupling's performance. Preload is a critical aspect of passive alignment coupling design, influencing its performance, stability, and reliability. Careful consideration of preload magnitude, application method, and its impact on other parameters is essential for achieving the desired functionality of the coupling. For example, kinematic couplings rely on specific point or line contacts to constrain motion. Preload ensures these contacts remain engaged, even under external loads or vibrations. Real-world surfaces aren't perfectly smooth. Preload helps to distribute contact forces and average out these imperfections, improving repeatability. A properly preloaded coupling is stiffer and more stable than one without preload, reducing unwanted movement and improving performance.

Ideally, the preload should be applied in a consistent manner that does not affect the integrity of the alignment function of the passive alignment features, to ensure consistent and reliable contact between the mating complementary passive alignment features, and to maintain elastic compliance and average out surface irregularities. Preload should be applied consistently and symmetrically to avoid introducing unwanted stresses or distortions in the coupling, and preload should not over-constrain the coupling, which can lead to binding or inaccurate positioning.

What is needed includes an improved demountable optical connector for passive alignment coupling with an improved preload feature, to achieve improved tolerance, manufacturability, ease of use, functionality and reliability at reduced costs.

### SUMMARY OF THE INVENTION

The present invention overcomes the drawbacks of prior art by providing an improved demountable/separable and reconnectable connection between an optical connector, or an optical connector assembly, and another device (e.g., another optical connector or an optoelectronic device such as photonic integrated circuits (PIC)), with an improved preload feature. In particular, this invention improves on the demountable optical connector disclosed in US Patent Publication No. 2016/0161686A1, commonly assigned to the assignee of the present invention, which is fully incorporated by reference herein, to include an improved means for implementing removable/separable and re-attachable coupling of optical connectors to other devices, in particular photonic integrated circuits (PICs) in optical alignment. For purpose of illustration and not limitation, the present invention will be described herein in connection with an optoelectronic device as an example of a device to which an optical connector supporting one or more optical fibers is demountable coupled.

The demountable connection includes a foundation and an optical connector that are configured and structured to be removably attached with each other in an optical alignment. The foundation may be deemed to function as a “receptacle” for mounting the optical connector, as such term is referenced in the optical connection field. Hereinafter, reference is generally made to “foundation”, which includes receptacles as that term is used in the optical connection field. The foundation may be an integral part of the optoelectronic device (e.g., a PIC or its associated packaging), or a separate component attached to the optoelectronic device.

In accordance with one embodiment of the present invention, the foundation is initially attached to a support (e.g., housing) of the optoelectronic device (e.g., PIC). This foundation can be aligned to electro-optical elements in the device. The foundation may be permanently attached with respect to the optoelectronic device. In one embodiment, the optical connector includes, as an integral part or separate part of its body, an optical bench which has defined thereon one or more structured reflective surfaces (in a linear array) supporting corresponding one or more optical fibers (in a linear fiber array). In one embodiment, the optical connector may be in the form of a micro-optical bench assembly (MOB assembly) that includes a connector body that supports a micro-optical bench having structured reflective surface(s) in the form of free surface mirrors defined thereon. The optical connector can be removably attached to the foundation, via a ‘separable’ or ‘demountable’ or ‘detachable’ action that accurately optically aligns the optical components/elements in the optical bench to the optoelectronic device along a desired optical path. During the optical alignment for each connect and disconnect and reconnect, this optical connector is desired to be precisely and accurately aligned to the foundation. In one embodiment of the present invention, the optical connector and foundation are aligned with one another using a passive mechanical alignment constructed from geometric features on them.

Passive alignment is implemented using kinematic coupling, quasi-kinematic coupling, or elastic-averaging couplings. One approach is a kinematic coupling with six points of contact between the optical connector and the foundation. In one embodiment, the connector body includes three coupling protrusions having generally three-dimensional convex surface profiles defined on the facing side or underside of the connector body that faces corresponding V-grooves on the facing top surface of the foundation. Each protrusion makes two points of contact with the corresponding V-groove on the facing surface of foundation, constituting a total of six contact points as required for static equilibrium, conforming to the configuration of a kinematic coupling.

In another embodiment, the protrusions are in the form of coupling beads or balls, each having generally three-dimensional convex surface profiles (e.g., spherical surface profiles), attached to the underside of the connector body that faces corresponding V-grooves on the facing top surface of the foundation. Upon coupling the connector body to the foundation, the coupling balls rest against the corresponding V-grooves on the facing surface of the foundation. Each coupling ball makes two points of contact with the corresponding V-groove, constituting a total of six contact points as required for static equilibrium, conforming to the configuration of a kinematic coupling. The coupling balls can be made from materials having specific properties (e.g., hardness) for purpose of maintaining dimensional stability for repeated coupling and decoupling of the connector body to the foundation, while the connector body can be made from materials having a different set of properties (e.g., certain coefficient of thermal expansion) suitable for its fabrication and function. In one embodiment, the coupling balls may be made of ruby, sapphire or any other hard material that can maintain dimensional stability at the contact points with the V-grooves.

In one embodiment, the connector body is detachably mounted to a frame of the foundation by the kinematic coupling, with a raised optical bench section of the connector body received in a central space of the foundation frame with a clearance. The coupling balls are attached to the thinner peripheral portions of the connector body. In one embodiment, the connector body and optical bench thereon are structured and configured such that after being kinematically coupled to the foundation, the location of the center mirror in the optical bench is located at the thermal center of the kinematic coupling (along the vertical line extending perpendicularly from the thermal center). By thinning the peripheral portions of the connector body to define the central raised section for the optical bench, a space is effectively provided between the connector body and the foundation to accommodate the coupling balls, and the raised section of the optical bench in the connector body is positioned closer to the optoelectronic device. The overall height of the demountable coupling above the optoelectronic device can be minimized.

With the connector body kinematically coupled to the foundation, physical disturbance (e.g., by thermal variations) on the connector body relative to the foundation would not appreciably affect the spatial position of at least the center mirror that is in line with the thermal center of the foundation. The other mirrors in the array may be slightly affected but such effect will be nominal or minimal for a given length of mirror array (e.g., 8- to 16-fiber array) and well within acceptable tolerance for optical alignment for purpose of optical data transmission.

In an alternate embodiment, V-grooves are instead provided on the connector body, and coupling balls are instead attached to the facing surface of the foundation.

Using epoxy, the coupling balls are attached to recesses or dimples defined on peripheral portions of the connector body, with the spherical surface of the coupling balls partially exposed above the surface of the peripheral portions of the connector body. Through holes are provided in the peripheral portions of the connector body to allow the epoxy to sip through without overflowing on the exposed portions of the coupling balls which include the two contact points against the corresponding V-groove on the foundation.

Alternatively, the coupling balls can be pressed into small holes and held in place by elastic forces as normally known as “press-fit” in the trade.

To maintain the connector body securely coupled to the foundation, a preload via an external bias is provided along the thermal center of the kinematic coupling of the connector body and the frame of the foundation, without introducing a lateral bias or restricting lateral movement of the connector body relative to the foundation. In one embodiment, the external bias is by a spring (e.g., a leaf spring), which biases a smooth tangential point contact defined by a generally three-dimensional convex protrusion (e.g., part of a spherical ball) against the back of the connector body, along the thermal center of the connector body and the foundation. A smooth contact may be achieved by a layer of polished glass provided on the back of the connector body, and further an appropriate lubricant/film may be provided on the surface of the glass.

An alternative approach that provides additional stiffness at the interface and reduces the dependence on the bending stiffness of the optical connector is to use a quasi-kinematic approach which adds additional contact points or replaces a contact point with a contact line. Additional contact points and contact lines increase the stiffness of the interface with modest reductions in repeatability. In this embodiment, the contact is spread over larger area between the two bodies and stiffens the bending modes of the optical connector. A further alternative embodiment maximizes the stiffness of the interface using many, perhaps hundreds or thousands, of contact points or small surfaces (e.g. tetrahedral) that are spread over as much area as possible. This requires accurate location of the mating surfaces and more stringent tolerances on the shape and size of the surfaces. However, this can be accomplished with ultra-high precision stamping.

Both the connector body and foundation should preferably have low and/or similar coefficient of thermal expansions (CTEs) to reduce misalignment under the impact of thermal variations and to prevent creation of thermoelastic stress/strains. As noted above, in the event of thermal variations, by locating the thermal centers of the foundation and connector body along the same vertical axis, the effect of thermal variation on the movement of the thermal centers would be minimized.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIGS. 1A and 1B illustrate an optical connector that can adopt the coupling balls and/or preload in accordance with one embodiment of the present invention.

FIGS. 2A to 2D illustrate coupling of the optical connector in FIGS. 1A to 1B to a foundation on an optoelectronic device.

FIGS. 3A to 3C illustrate various embodiments of passive alignment couplings that can adopt a preload via a smooth tangent point external biasing in accordance with the present invention.

FIGS. 4A to 4D illustrate an alternative embodiment of passive alignment coupling of an optical connector directly to the package of the optoelectronic device in accordance with one embodiment of the present invention.

FIG. 5 is a schematic sectional view taken along the centerline 5-5 in FIG. 4B, of a kinematically coupled optical connector assembly and foundation on an optoelectronic device on a printed circuit board (PCB), subjected to a preload via a smooth tangent point external biasing in accordance with one embodiment of the present invention.

FIG. 6 is a photographic view of a prototype assembly of the kinematic coupling of optical connector assembly and foundation in accordance with one embodiment of the present invention.

FIG. 7 is a photographic view of the prototype assembly on a test stand, subject to testing by a test probe to determine extent of lateral positional variances of the optical connector assembly upon connection, disconnection and reconnection to the foundation.

### DETAILED DESCRIPTION OF THE PREFERRED EMBODIMENTS

The present invention provides an improved demountable/separable and reconnectable connection between an optical connector (supporting one or more optical fibers) and another device (e.g., another optical connector or an optoelectronic device such as photonic integrated circuits (PIC) having a grating coupler), with an improved preload feature. In particular, this invention improves on the demountable optical connector disclosed in US Patent Publication No. 2016/0161686A1, commonly assigned to the assignee of the present invention, which is fully incorporated by reference herein, to include an improved means for achieving removable/separable and re-attachable coupling of optical connectors to other devices, in particular photonic integrated circuits (PICs) in optical alignment.

For purpose of illustration and not limitation, the concept of the present invention will be described herein in connection with an optoelectronic device as an example of a device to which the optical connector is demountable coupled. Further, the concept of the present invention will be discussed with reference to an example of a PIC as an optoelectronic device, and an optical bench as an optical coupling device in an optical connector (e.g., optical bench as an integral or a separate part of optical connector) that optically couple an input/output end of an optical component (e.g., an optical fiber) supported in the optical bench with the optical input/output of the optoelectronic device. The present invention may be applied to provide removable/reconnectable structures for, e.g., another optical connector, or used in other fields.

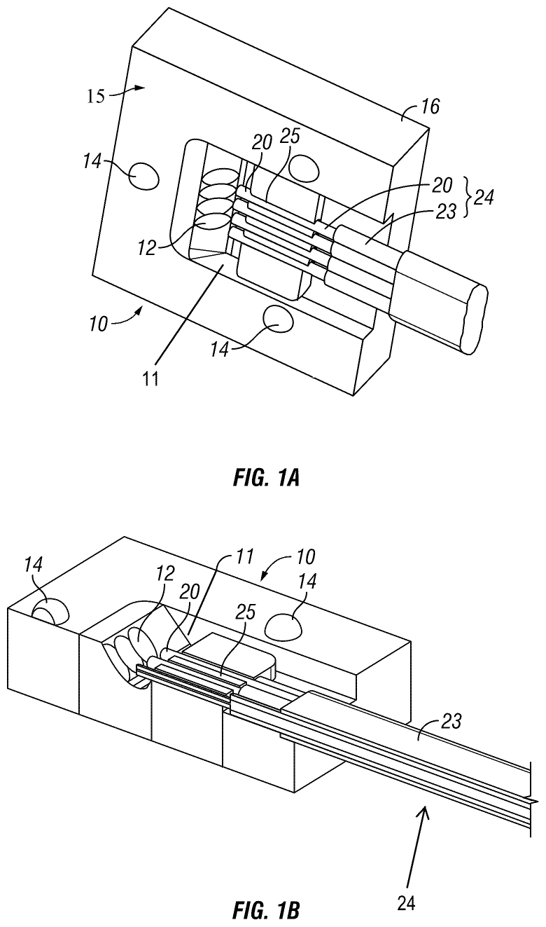

Reference is made to the invention disclosed in US Patent Publication No. 2016/0161686A1, which can be modified to incorporate the inventive improvements disclosed hereinafter. FIGS. 1A and 1B illustrate an optical connector 10 which can be modified to adopt the present invention (e.g., incorporating the coupling balls and the external bias preload disclosed herein below). As illustrated, the optical connector 10 incorporates a micro-optical bench 11 supporting optical components in the form of optical fibers 20. In the embodiment in FIGS. 1A and 1B, the optical bench 11 is a separate part supported by a body 16 of the optical connector 10. Alternatively, not shown, the optical bench 11 may be an integral part of the optical connector body 16 (i.e., the body 16 can integrally define the structured features of the optical bench 11 discussed below).

In the illustrated embodiment, the optical bench 11 defines structured features including an alignment structure comprising open grooves 25 for retaining bare sections of optical fibers 20 (having cladding exposed, without protective buffer and jacket layers 23), and four structured reflective surfaces 12 (e.g., free surface mirrors each having a structured reflective surface profile) having a plane inclined at an angle relative to the greater plane of the base 16. The optical fiber cable 24 has four optical fibers 20 protected by protective buffer and jacket layers 23. For simplicity, the embodiment of the optical connector 10 schematically illustrated in FIGS. 1A and 1B includes four optical fibers and four mirrors. It is understood that a similar optical connector incorporating an optical bench may be implemented to support more optical fibers and more mirrors defined thereon without departing from the scope and spirit of the present invention.

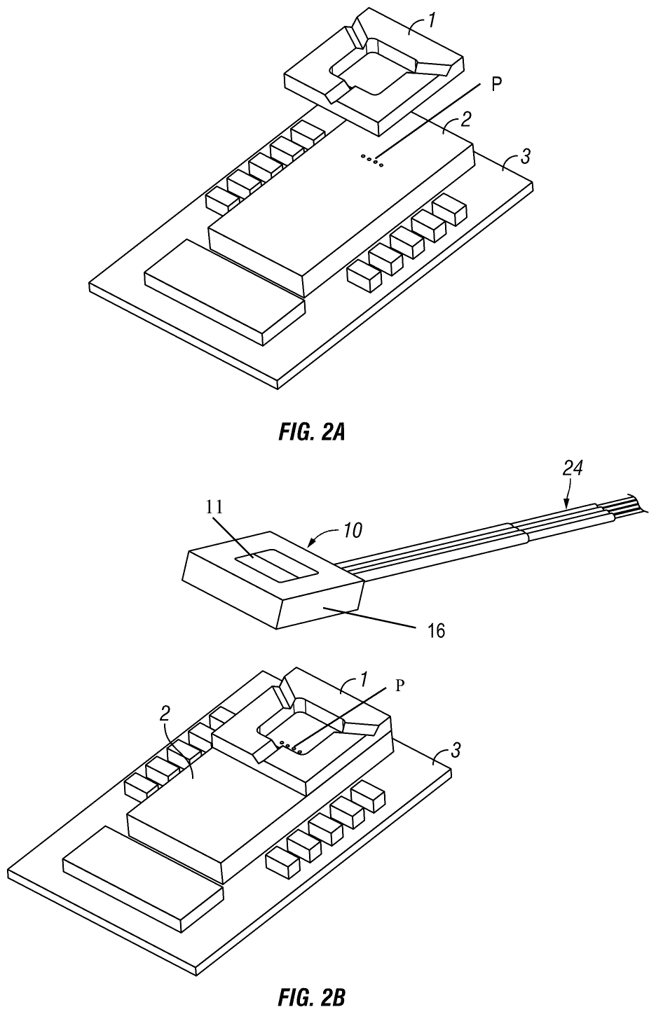

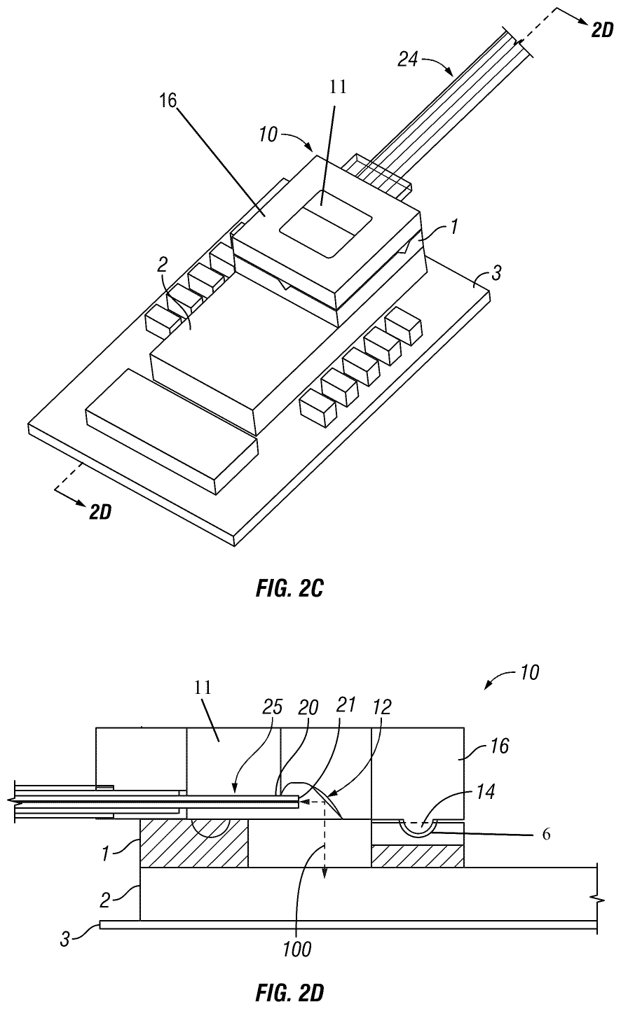

Each structured reflective surface 12 may have a flat, concave or convex surface profile and/or possess optical characteristics corresponding to at least one of the following equivalent optical elements: mirror, focusing lens, diverging lens, diffraction grating, or a combination of the foregoing. The structured reflective surface 12 may have a compound profile defining more than one region corresponding to a different equivalent optical element (e.g., a central region that is focusing surrounded by an annular region that is diverging). In one embodiment, the structured reflective surface 12 may have a concave aspherical reflective surface profile, which serves both functions of reflecting and reshaping (e.g., collimating or focusing) a diverging incident light, without requiring a lens. Accordingly, each structured reflective surface 12 functions as an optical element that directs light to/from an external optical component (in this case an optoelectronic component, such as PIC 2, by reflection from/to the output/input end 21 (as shown in FIG. 2D) of the optical fiber 20, along a defined optical path 100 (schematically shown in FIG. 2D) that is aligned to the optical axis of the various optical components and elements (i.e., optical fibers 20, structured reflective surfaces 12, and PIC 2).

In another embodiment, instead of free surface mirrors, the structured reflective surfaces may be implemented by light transparent structures having structured surfaces (which may be coated externally) reflecting light through the body of the light transparent structures.

Open grooves 25 are sized to receive and are located to precisely position the end section of the optical fibers 20 in alignment with respect to the structured reflective surfaces 12 along the optical path 100. The end face 21 (input/output end) of each optical fiber 20 is maintained at a pre-defined distance with respect to a corresponding structured reflective surface 12.

The mirror/structured reflective surface and optical fiber alignment structure in the optical connector can be integrally/simultaneous formed by precision manufacture (e.g., stamping, etching, etc.) of a stock material (e.g., a metal blank or strip), which allows the optical connector components to be produced economically in high or small volumes, while improving tolerance, manufacturability, ease of use, functionality and reliability. By forming the structured reflective surface, the passive alignment features (discussed below) and the optical fiber alignment structure simultaneously in a same, single final stamping operation, dimensional relationship of all features requiring alignment on the same work piece/part can be maintained in the final stamping step. Instead of a punching operation with a single strike of the punch to form all the features on the optical bench, it is conceivable that multiple strikes may be implemented to progressive pre-form certain features on the optical bench, with a final strike to simultaneously define the final dimensions, geometries and/or finishes of the various structured features on the optical bench, including the mirror, optical fiber alignment structure/groove, passive alignment features discussed below, etc. that are required to ensure (or play significant role in ensuring) proper alignment of the respective components/structures along the designed optical path.

The Assignee of the present invention developed various proprietary optical coupling/connection devices having optical benches used in connection with optical data transmission. The present invention is more specifically directed to detachably/reconnectably coupling optical device to grating couplers in PICs, while adopting similar concept of stamping optical benches including stamped mirrors practiced in the earlier optical coupling devices. References to relevant earlier patent documents can be found in US Patent Publication No. 2016/0161686A1 (e.g., U.S. Pat. Nos. 7,343,770; 10,413,953; and U.S. Patent Publication Nos. US2013/0322818A1, US2013/0294732A1; commonly assigned to the assignee of the present invention, which are incorporated by reference herein). The overall functional structures of the optical bench 11 generally resemble the structures of some of the optical bench embodiments disclosed in Assignee's patent documents noted above (i.e., fiber alignment grooves aligned with structured reflective surfaces, and addition features to facilitate proper optical alignment).

By including the grooves 25 on the same, single structure that also defines the structured reflective surfaces 12, the alignment of the end faces 21 of the optical fibers 20 to the structured reflective surfaces 12 can be more precisely achieved with relatively smaller tolerances by a single final stamping to simultaneous define the final structure on a single part, as compared to trying to achieve similar alignment based on features defined on separate parts or structures. By forming the structured reflective surfaces 12 and the optical fiber alignment structure/grooves 25 simultaneously in a same, single final stamping operation, dimensional relationship of all features/components requiring (or play a role in providing) alignment on the same work piece/part can be maintained in the final stamping step.

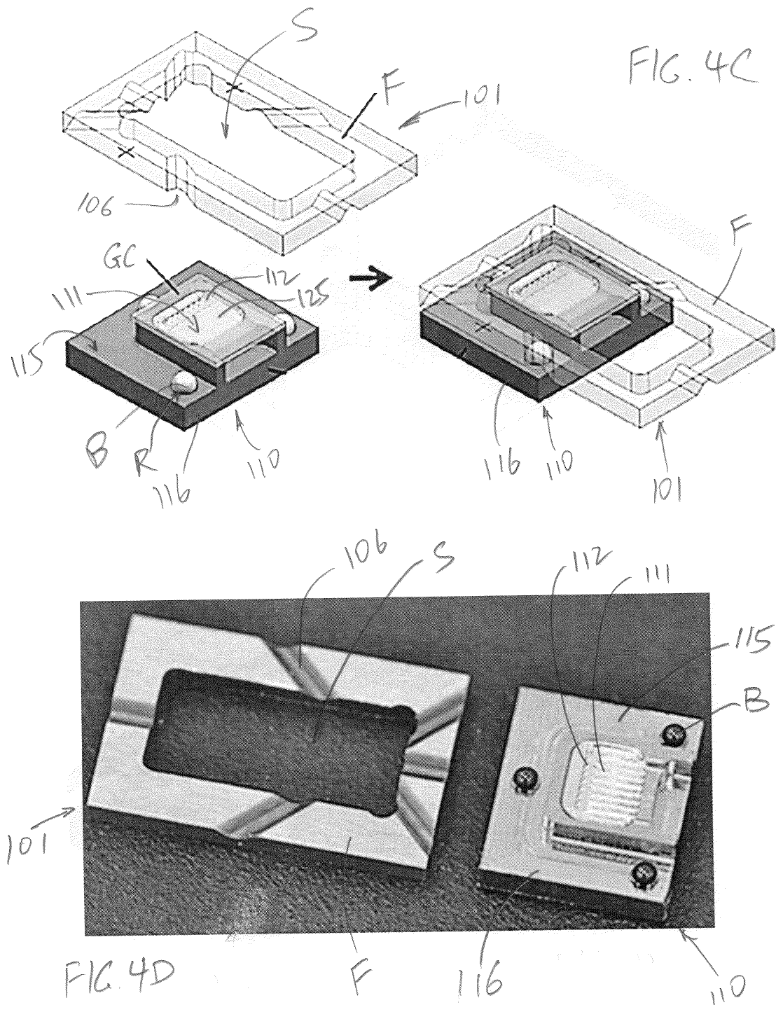

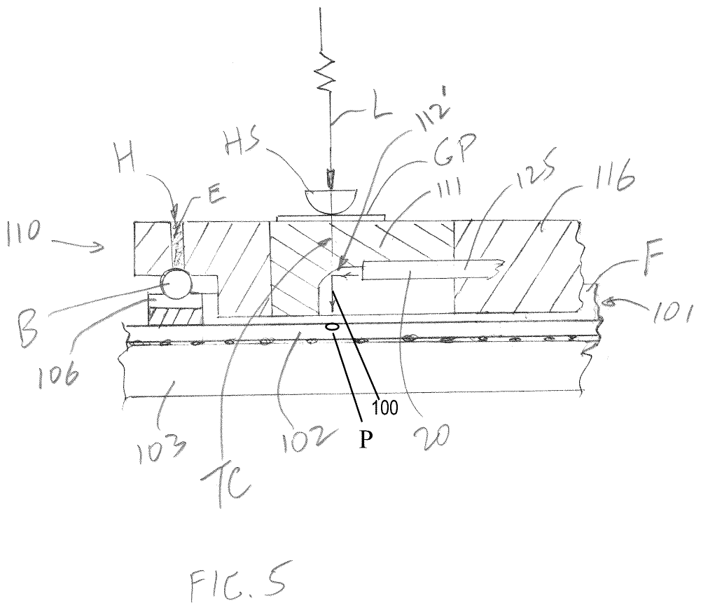

In the views of FIGS. 1A and 1B, mechanical passive alignment features 14 are formed on the planar surface 15 at the underside of the body 16, which facilitates alignment and/or accurate positioning the optical bench 11 with respect to PIC 2, as will be explained later below. In accordance with the improvement of the present invention, the alignment features 14 can be modified to implement the coupling balls as discussed below in connection with the embodiment of FIGS. 4A to 4D.

Referring to FIGS. 2A to 2D, a foundation 1 serves as a receptacle to mechanically couple with the body 16 of the optical connector 10, to enable the optical bench 11 in optical alignment with the PIC 2. Foundation 1 is attached to the top surface of PIC 2, at a precise location such that when the optical connector 10 is connected to the foundation 1, the optical bench 11, especially the structured reflective surfaces 12 would be in optical alignment with the electro-optical components in the underlying PIC 2. Preferably, foundation 1 is initially attached to PIC 2 at wafer-level prior to dicing process. Foundation 1 can be positioned with reference to optical input/output ports P (e.g., defined by grating couplers) of PIC 2 using precise machinery and then permanently joined to the PIC via epoxy or solder. Foundation 1 remains attached to PIC 2 during the dicing and packaging processes. The packaged die is then mounted onto the printed circuit board 3 (PCB) using conventional PCB assembly methods (e.g. pick-and-place and wave soldering). This requires that the foundation be able to withstand the elevated temperatures during the soldering operations.

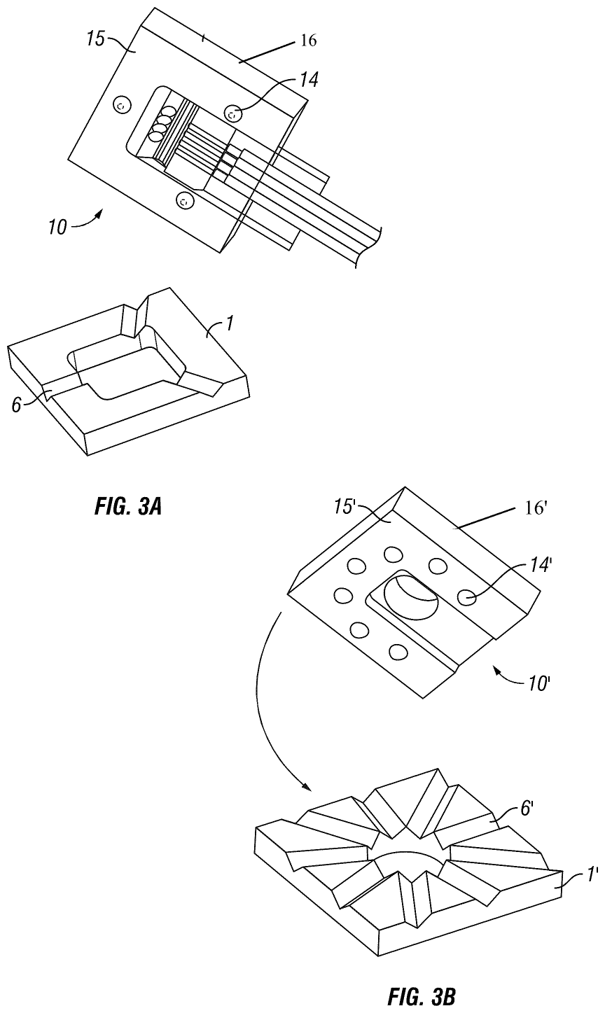

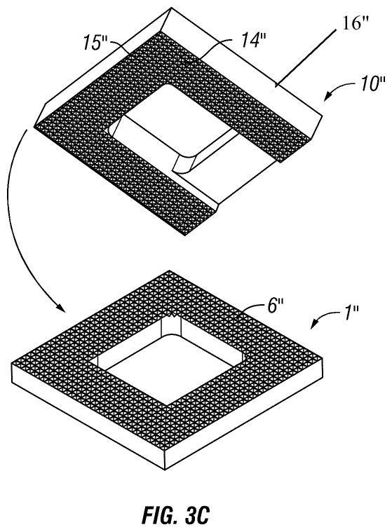

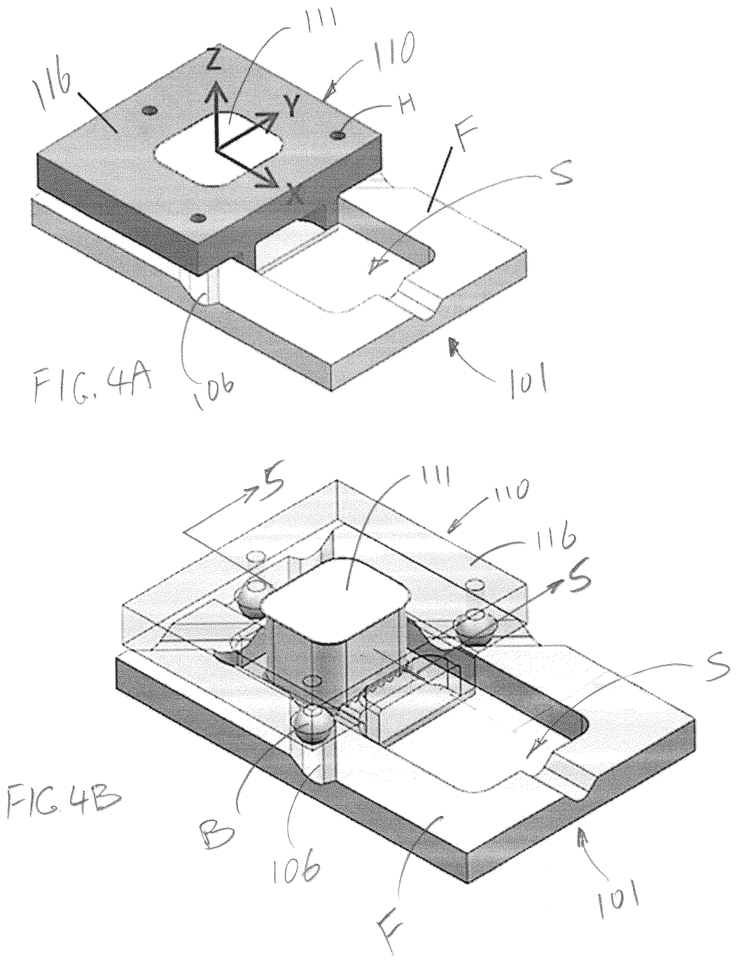

The foundation 1 is provided with passive alignment features matching/complementing the alignment features 14 at the under surface 15 of the connector body 16. This aspect will be discussed below in connection with the passive alignment approaches in reference to FIGS. 3A to 3C.

Referring to FIG. 2B, after the PCB 3 is populated with other items (not shown and labeled in FIG. 2A), an optical fiber cable 24 supported by the optical connector 10 can be removably attached to the foundation 1 or detached from the foundation 1 that is permanently mounted on the PIC 2, via a ‘separable’, ‘demountable’, ‘detachable’, or ‘re-attachable’ action that accurately aligns the input/output ends 21 of the optical fibers 20 with the optical input/output ports P (and thus the active electro-optical elements) on the PIC 2 along the optical path 100. FIG. 2D is a sectional view illustrating the state of FIG. 2C, in which the optical connector 10 is attached to the foundation 1 on PIC 2 that is supported on PCB3. The foundation 1 and the optical connector 10 could be maintained in a coupled state by the preload discussed below in connection with FIG. 5 to maintain the physical/mechanical connection of the optical connector 10 against the foundation 1.

The invention may use different embodiments for aligning the optical connector to the foundation. In accordance with the present invention, the optical connector and foundation are aligned with one another using a passive mechanical alignment constructed from facing surface geometric features on the two bodies. Such passive alignment features may conform to one of kinematic coupling, quasi-kinematic coupling, or elastic-averaging coupling. Each type of passive alignment coupling involves a different configuration of complementary passive alignment features. FIGS. 3A to 3C illustrates various embodiments of passive alignments adopting various coupling approaches.

FIG. 3A shows the first approach, which is a kinematic coupling with six points of contact between the optical connector 10 and the foundation 1. FIG. 3A is similar to the embodiment shown in FIGS. 2A and 2D. There are three semi-circular protrusions 14 (which may be implemented as coupling balls discussed in connection with FIGS. 4A to 4D below) on the under surface 15, and three complementary grooves 6 (which may having a generally V-shape cross section) on the top surface of the foundation 1. The grooves 6 are in a direction radiating from the center of the foundation 1. Six points are the minimum necessary for rigid body static equilibrium and consequently provide a deterministic and repeatable alignment between the bodies. Since there are only six contact points, there is minimum chance of the alignment being influenced by particles between the mating surfaces of the optical bench 11 and the foundation 1. The portions of the optical connector 10 that are not immediately near the contact points are stiffened only by the bending stiffness of the optical connector 10.

FIGS. 4A to 4D illustrate a further embodiment of demountable kinematic coupling of an optical connector 110 and a foundation 101. In this embodiment, the structural features of the optical connector 110 and foundation 101 generally resemble corresponding structural features of the optical connector 10 in FIGS. 1A and 1B and the foundation 1 in FIGS. 2A to 2D, with the exception of the additional features further discussed below.

Referring to the embodiment of FIGS. 4A to 4D, the optical connector 110 includes a body 116 and an optical bench 111 having a set of grooves 125 for maintaining spatial and direction alignments of adjacent optical fibers 20 (shown in the centerline sectional view in FIG. 5), and a corresponding array of mirrors 112, with the ends of the optical fibers 20 optically aligned to the mirrors 112. Fiber grooves 125 and mirrors 112 can also be formed by a stamping process (e.g., stamping a malleable metal base to simultaneously form fiber grooves 125 and reflective surfaces 112). Other components of the optical connector 110 have been omitted so as not to obscure illustration of the primary components.

Unlike the earlier embodiments, as shown in FIG. 4C, the optical bench 111 supports the fiber grooves 125 and the mirrors 112 in a central raised/protruding position which has a higher height than the peripheral portion of the connector body 116. A glass cover GC is provided to cover the optical bench 111 to protect the components on the optical bench. A similar cover may be provided on the optical bench 11 in the earlier embodiment.

Unlike the earlier embodiment, the foundation 101 has a through opening defining a space S surrounded by a frame F that is large enough to receive the raised portion of the optical bench 111 with a clearance. Frame F of the foundation 101 includes a set of grooves, e.g., V-grooves 106 provided on the surface facing the optical connector 110. The longitudinal axis of the V-grooves 106 extends across the different sections of the surrounding frame F, towards the space S, to meet at a “thermal center” in the space S, as is known in connection with kinematic couplings. There are at least three grooves 106 across the frame, matching the three coupling balls B. The geometries, placements and orientations of grooves 106 are similar to that of the earlier described embodiment of grooves 6 on foundation 1 in FIGS. 2A and 3A.

Similar to the previous embodiment, in FIG. 5, PIC 102 is soldered onto the surface of PCB 103. Foundation 101, having the space S surrounded by the frame F, is mounted to PIC 102 (or to the PCB 103 directly if the PIC 102 or other optoelectronic device is small enough to rest within frame F of foundation 101). The optical connector 110 is detachably mounted to frame F of foundation 101 by kinematic coupling in this embodiment.

As in the previous embodiment, passive alignment features in the form of protrusions are provided on the underside surface 115 of the connector body 116 for kinematic coupling. In this embodiment, the protrusions are in the form of coupling beads or balls B, each having generally three-dimensional convex surface profiles (e.g., spherical surface profiles), attached to the underside 115 of the connector body 116 that faces corresponding V-grooves 106 on the facing top surface of the foundation 101/frame F. Specifically, in the illustrated embodiment, the coupling balls B are attached to the lower peripheral portions (i.e., portions outside the raised/protruded portion of the optical bench 111) of the connector body 116. The three coupling balls are distributed in a triangular arrangement on the surface 115. The placements of coupling balls B are similar to that of the earlier described embodiment of protrusions on surface 15 of the optical connector 10 in FIG. 1A. Upon coupling to foundation 101, the coupling balls B rest against the corresponding V-grooves 106 on the facing surface of the frame F of the foundation 101. Each coupling ball B makes two points of contact with the corresponding V-groove 106, constituting a total of six contact points as required for static equilibrium, conforming to the configuration of a kinematic coupling.

The coupling balls can be made from materials having specific properties (e.g., hardness) for purpose of maintaining dimensional stability for repeated coupling and decoupling of the connector body to the foundation, while the connector body can be made from materials having a different set of properties (e.g., certain coefficient of thermal expansion) suitable for its fabrication and function. In one embodiment, the coupling balls B may be made of ruby, sapphire or any other hard material that can maintain dimensional stability at the contact points with the V-grooves 106 on the foundation frame F. Using epoxy E, the coupling balls B are attached to recesses R or dimples defined on peripheral portions of the connector body 116, with the spherical surface of the coupling balls B partially exposed above the surface 115 of the peripheral portions of the connector body 116. Through holes H are provided in the peripheral portions of the connector body 116 to allow the epoxy to sip through without overflowing on the exposed portions of the coupling balls which include the two contact points against the corresponding V-groove on the foundation. Alternatively, the coupling balls can be pressed into small holes in the connector body 16 and held in place by elastic forces as normally known as “press-fit” in the trade.

In an alternative embodiment, not shown, V-grooves are instead provided on the connector body facing surface (e.g., 15, 115), and coupling balls are instead attached to the facing surface of the foundation. This embodiment is beneficial in dirty environments where dust or particles are present since the convex surfaces of the coupling balls tend to cause particles landing on the convex surfaces to fall away from the vicinity of the kinematic contact points and are not trapped in V-grooves.

FIG. 5 is a schematic sectional view taken along line 5-5 in FIG. 4B, depicting the symmetry centerline plane of the kinematically coupled optical connector assembly 110 and foundation 101 on an optoelectronic device on a printed circuit board (PCB), subjected to a preload via a smooth tangent point external biasing in accordance with one embodiment of the present invention. This symmetrical plane passes through the centermost mirror 112′. As shown in FIG. 5, the central raised portion of the optical bench 111 is received in space S with a clearance. The connector body 116 and optical bench 111 thereon are structured and configured such that after being kinematically coupled to the frame F of the foundation 101, the location of the center mirror 112′ in the optical bench 111 is located at the thermal center of the kinematic coupling of the connector body 116 to the frame F (along the vertical line TC extending perpendicularly from the thermal center). Ideally, the line TC coincides with the optical axis of the light between the center mirror 112′ and the optical ports P of PIC 102. With the connector body 116 kinematically coupled to foundation 101, physical disturbances (e.g., by thermal variations) on the connector body 116 relative to foundation 101 would not appreciably affect the spatial position of at least the center mirror 112′ that is along the thermal center line TC through the thermal center of the foundation 101. The other mirrors 112 in the array may be slightly affected but such effect will be nominal or minimal for a given length of mirror array (e.g., 8- to 16-fiber array) and well within acceptable tolerance for optical alignment for purpose of optical data transmission.

It is noted that the thermal center is a property of the mated bodies that are kinematically coupled together. The thermal center is identified as the intersection of three lines that originate at the centers of the balls and point along the direction of the V-grooves. When the two kinematically coupled bodies expand (or contract) due to uniform thermal expansion, objects that are at the thermal center tend to remain at the thermal center. Consequently, placing the centermost mirror at the thermal center minimizes the shift in the location of the mirrors due to temperature changes. Consequently, the center of mirrors 112 remains aligned with the center of the I/O ports P on the PIC 102.

By thinning the peripheral portions of the connector body to define the central raised section of the optical bench 111, i.e., arranging the optical bench 111 and the coupling balls B at surfaces with different levels of the connector body 116, a space is effectively provided between the connector body 116 and the frame F of the foundation 101 to accommodate the coupling balls B without compromising overall height of the overall structure. Larger size coupling balls can be selected for better coupling stiffness and lower stress at the contact points. Placing the raised section of the optical bench 111 of the connector body 116 into the space S surrounded by the frame F of the foundation 101, the optical bench 111 can be positioned closer to the optical I/O ports P of optoelectronic device/PIC 102 to shorten the optical path to minimize light deviations from variations in the positions and orientation of the mirrors 112. The overall height of the demountable coupling above the optoelectronic device can be minimized for an optical bench of a given size, comparing the embodiment in FIG. 5 to the previous embodiment shown in, e.g., FIG. 2D.

To maintain the connector body 116 securely coupled to the foundation 101, a preload L via an external bias is provided along the thermal center line TC of the kinematic coupling of the connector body 116 and the foundation 101, as depicted in FIG. 5, without introducing a lateral bias or restricting lateral movement of the connector body 116 relative to the foundation 101.

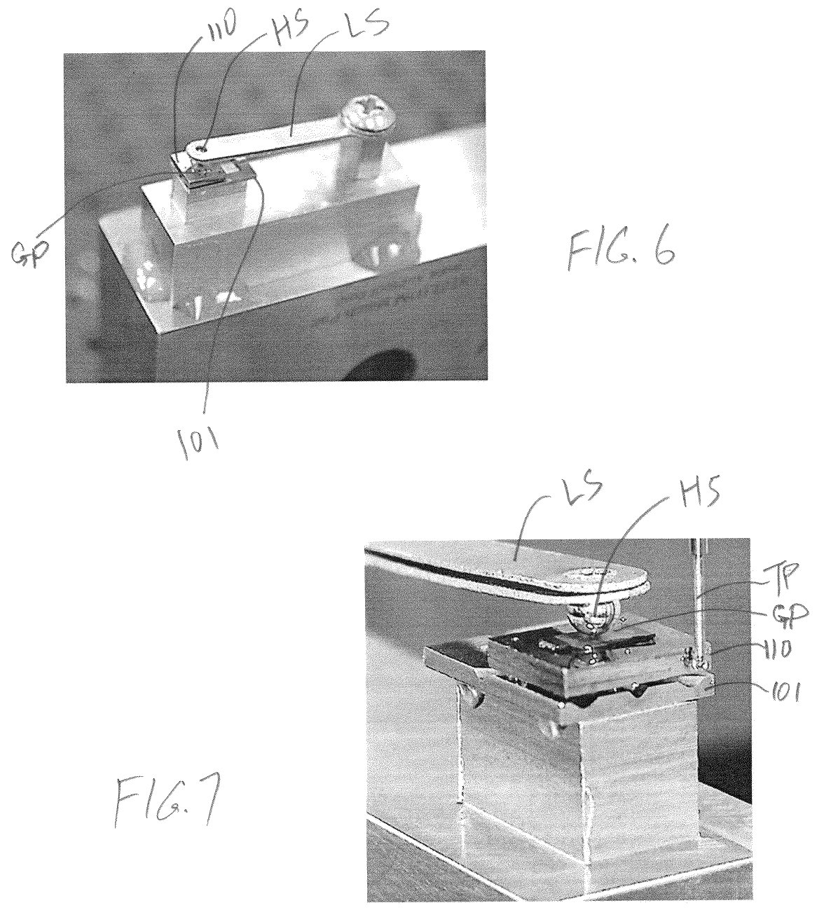

FIG. 6 is a photographic view of a prototype assembly of the kinematic coupling of an optical connector 110 and foundation 101, in accordance with one embodiment of the present invention. In this embodiment, the external bias is applied by a spring (e.g., a cantilevered leaf spring LS), which biases a smooth tangential point contact defined by a generally three-dimensional convex protrusion (e.g., part of a spherical ball, such as a hemisphere HS) against the back of the optical connector 110, along the thermal center line TC of the kinematically coupled optical connector 110 and the foundation 101. A smooth contact may be achieved by a layer of a polished glass plate GP attached to the back surface of the optical connector 110, and further an appropriate lubricant/film may be provided on the surface of the glass plate GP. The smooth contact minimizes or eliminates lateral bias introduced on the optical connector 110 relative to the foundation 101. The spherical surface could be defined by a body made of sapphire, ruby, or any other hard material that can maintain the tangent point contact with the glass plate GP.

FIG. 7 is a photographic view of the prototype assembly on a test stand, subject to testing by a test probe TP to determine the extent of the lateral positional variances of the optical connector assembly 110 upon connection, disconnection and reconnection to foundation 101. Test results showed the lateral positional variances to be within acceptable range.

In summary, for the embodiment illustrated in FIGS. 4A to 4D, and FIG. 5, the process for implementing demountable coupling an optical connector 110 to a foundation 101 includes the following sequence of forming/assembling:
1. Coupling the optical connector 110 to the foundation 101 with the coupling balls B received in the grooves 106 in a kinematic coupled manner;
2. Placing the kinematically coupled optical connector 110 and foundation 101 combination on the PIC;
3. Actively aligning the optical fibers 20 on the optical connector 110 to the PIC's optical ports P by moving the coupled foundation 101 and optical connector 110 combination, until desired optical alignment is achieved; and
4. Affixing the foundation 101 to the PIC 102 at the aligned position; and
5. Attaching PIC 102 onto PCB 103 (relying on passive alignment to position the PIC at the desired location on the PCB, e.g., precision pick-and-place and wave-soldering).

After affixing the foundation 101 to the PIC 102, the optical connector 110 can be removed and subsequently remounted by kinematic coupling to the foundation 101. Given the kinematic coupling, the optical fibers in the optical connector 110 are optically aligned to the optical ports P on the PIC 102 along the optical path 100. Based on repeatability experiments, optical alignments of repeated remove and remount are within acceptable tolerances for an effective optical connector for optical data transmission.

Alternatively, by making the foundation 101 and the connector body 116 out of magnetized or magnetizable material, or otherwise providing magnetic attraction between the connector body 116 and the foundation 101, steps 2 to 4 discussed above may be carried out without requiring a separate clamping device to maintain the connector body 116 coupled to the foundation 101 during active alignment and affixing the foundation 101 to the PCB 103.

An alternative to magnetic attachment for active alignment would be to use a vacuum gripper that pulls the foundation 101 toward the optical connector 110 during active alignment of the optical fibers to the PIC.

An alternative approach that provides additional stiffness at the interface and reduces the dependence on the bending stiffness of the optical connector is to use a quasi-kinematic approach which adds additional contact points or replaces a contact point with a contact line. Additional contact points and contact lines increase the stiffness of the interface with modest reductions in repeatability. In this embodiment, the contact is spread over a larger area between the two bodies and stiffens the bending modes of the connector body. FIG. 3B shows an example of this alternative approach that provides additional stiffness at the interface of the optical connector 10′ and the foundation 1′ and reduces the dependence on the bending stiffness of the connector body 16′. This approach conforms to a quasi-kinematic coupling, which adds additional contact points or replaces a contact point with a contact line. In this embodiment, more semi-circular protrusions 14′ are provided on the surface 15′ of the connector body 16′, and more complementary V-grooves 6′ are provided on the top surface of foundation 1. The protrusions can be implemented with coupling balls as described in connection with the embodiment in FIGS. 4A to 4D. Further, a similar external bias as in FIG. 5 can be implemented to apply a preload along the thermal center line through the thermal center of the coupled connector body 16′ to the foundation 1′, without introducing a lateral bias or restricting lateral movement on the optical connector 10′.

A further alternative embodiment maximizes the stiffness of the interface using many, perhaps hundreds or thousands, of contact points or small surfaces (e.g. tetrahedral) that are spread over as much area as possible. This requires accurate location of the mating surfaces and more stringent tolerances on the shape and size of the surfaces. However, this can be accomplished with ultra-high precision stamping or etching. FIG. 3C shows an example of demountable coupling of an optical connector 10″ and a foundation 1″ based on an elastic averaging coupling. This coupling maximizes the stiffness of the interface using passive alignment features that include many, perhaps hundreds or thousands, of contact points or small surfaces (e.g. tetrahedral) that are spread over as much surface area as possible. This embodiment requires accurate location of the mating surfaces and more stringent tolerances on the shape and size of the surfaces. However, this can be accomplished with ultra-high precision stamping or etching the top surface of the foundation 1″ with the numerous contact points (e.g., tetrahedral) and the top surface 15″ of the connector body 16″ with the numerous contact points (e.g., tetrahedral). Further, a similar external bias as in FIG. 5 can be implemented to apply a preload along the thermal center line through the thermal center of the coupled connector body 16″ to the foundation 1″, without introducing a lateral bias or restricting lateral movement on the optical connector 10″.

In all the above-described embodiments, both the foundation and the optical connector including its body and optical bench should preferably have low and/or similar coefficient of thermal expansions (CTEs) to reduce misalignment during temperature cycles and to prevent creation of thermoelastic stress/strains. As noted above, in the event of thermal variations, objects that are located at or close to the vertical axis through the thermal centers of the coupled foundation and connector body would not shift appreciably. Consequently, placing the centermost mirror at the thermal center minimizes the shift in the location of the mirrors due to temperature changes. Consequently, the center of the mirrors remains aligned with the center of the optical I/O ports on the PIC.

In all the above-described embodiments, either or both of the foundation and the connector body, including the passive alignment features, can be precisely formed by high-precision stamping a ductile metal such as Kovar, Invar, stainless steel, aluminum.

Alternatively, the foundation and/or connector body may be made of glass. If epoxy is used to attach to the foundation to the PIC, then the subsequent process temperatures should not exceed the temperature limit of the epoxy. Solder attachment of the foundation to the PIC can provide higher process temperatures.

The passive alignment couplings described above allow an optical connector to be detachably coupled to the PIC via a foundation. The optical connector can be detached from the foundation and reattached to the foundation without compromising optical alignment. An external bias applies a preload along the line through the thermal center of the coupled optical connector to the foundation, without introducing lateral bias on the optical connector.

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

We claim:

1. A connection structure between an optical connector and a device, comprising the structure as illustrated and described.
